(19) United States
(12) Patent Application Publication
(10) Pub. No.: US 2023/0017760 A1
(43) Pub. Date: Jan. 19, 2023

(54) METHOD FOR DETERMINING A TRAJECTORY OF AN AIRCRAFT

(71) Applicant: THALES, COURBEVOIE (FR)

(72) Inventors: Damien GOUBINAT, TOULOUSE (FR); Christophe PIERRE, TOULOUSE (FR); Guillaume GOUTTEBROZE, TOULOUSE (FR)

(21) Appl. No.: 17/861,986

(22) Filed: Jul. 11, 2022

(30) Foreign Application Priority Data
Jul. 15, 2021 (FR) 2107655

(51) Int. Cl. G08G 5/00

(52) U.S. Cl. CPC G08G 5/0039; G08G 5/006; G08G 5/0043; G08G 5/0073

(57) ABSTRACT

A method for determining a trajectory of an aircraft intended to fly over a field of operation with a view to performing an action on a target at a given time is provided. The method comprises a step of computing a set of sections between a starting point, intermediate points and the target. A first type of section has a rectilinear overall shape so as to limit the time spent by the aircraft in non-secure areas. A second type of section has a sinusoidal shape so as to allow a time reserve to adjust a position of the aircraft over the target at said given time with a view to performing the action.

### CROSS-REFERENCE TO RELATED APPLICATION

This application claims priority to foreign French patent application No. FR 2107655, filed on Jul. 15, 2021, the disclosure of which is incorporated by reference in its entirety.

### FIELD OF THE INVENTION

The present invention relates to a method for determining a trajectory of an aircraft, to a method for synchronization between multiple aircraft, and to the associated devices.

### BACKGROUND

For any aerial military operation contemplated on a determined mobile or fixed target, the phase of preparing the action is essential. Nowadays, it is operators who prepare missions manually on the ground using a tactical situation that is available far enough in advance. On the basis of these events, these operators determine a flight plan and a trajectory to be followed by the aircraft to perform its mission. These elements are then integrated into the flight management system (FMS), which makes this trajectory available to the pilot.

The operators may include “fuses” in the trajectory, which make it possible to adjust the time of the flight with a view to hitting the target at the appropriate time. It is known to a person skilled in the art to use isosceles triangles to form said fuses. These isosceles triangles make it possible to extend the trajectory in order to guard against randoms. These triangles have a length determined so as to contain an amount of time that is easy to remember for the pilot (one minute for example). Depending on the progress of the mission and the randoms encountered, pilots follow or remove these fuses on their trajectory so as to extend or shorten their trajectory and thus comply with the time constraint.

Although the use of isosceles triangles makes it possible to adjust the trajectory of the aircraft during the flight, it however requires particular attention from the pilot to decide to remove or to follow these triangles. The mental load on the pilot is then increased during the flight with this trajectory management method. Furthermore, the evolution of the tactical situation on the field of operation is not actually taken into account, since the pilot is not able to have direct access to this information. He is therefore not able to knowingly decide on the opportunity of removing or following these fuses from a tactical point of view.

There is therefore a need to provide a method for determining a trajectory of an aircraft that is easier to implement and that takes into account the evolution of the tactical situation on the field of operation.

### SUMMARY OF THE INVENTION

The present invention aims to at least partially rectify this need.

More specifically, the present invention aims to facilitate the use of secure areas in order to generate possibilities of time losses during a flight through the use of predetermined trajectory shapes.

A first subject of the invention relates to a method for determining a trajectory of an aircraft intended to fly over a field of operation with a view to performing an action on a target at a given time. The field of operation comprises a plurality of secure areas and a plurality of non-secure areas. The trajectory comprises a plurality of intermediate points between a starting point of said trajectory and the target, said intermediate points being positioned on borders between secure areas and non-secure areas. The method is implemented by computerized means. The determination method comprises a step of computing a set of sections between said starting point, said intermediate points and said target. The set of sections comprises a first type of section extending over non-secure areas and a second type of section extending over secure areas. The first type of section has a rectilinear overall shape so as to limit the time spent by the aircraft in the non-secure areas and said second type of section has a sinusoidal shape so as to allow a time reserve to adjust the position of the aircraft with respect to the target over time.

The invention thus proposes to determine or to assign risk levels to the various areas of the field of operation. For reasons of implementing the operation, it is sometimes necessary for the aircraft to fly over non-secure areas having a high risk level. It is sought to minimize the time the aircraft is present in a non-secure area. The trajectory will then have a rectilinear overall shape. A “rectilinear shape” is understood to mean a shape that is in a straight line. The secure areas having a lower risk level will be able to constitute time reserves. In these secure areas, the trajectory of the aircraft will be able to take a sinusoidal shape so as to make it possible to extend the flight time with a view to synchronizing the aircraft with the target. It is thus possible to modify parameters in terms of distance, duration, inter-segment route angle variation, speed and gradient on the section in order to obtain such a sinusoidal shape. The sinusoidal shape is also called a non-rectilinear shape. The method thus makes it possible to extend the trajectory using trajectory portions that are flyable and whose length/duration may vary during the flight. The trajectory portions are determined in advance and constitute time loss “patterns”. These time loss patterns may result from a numerical optimization or else stem from the expertise of the pilots. Finally, the method improves the overall autonomy of the aircraft.

In one particular embodiment, the step of computing the set of sections is performed based on:

a trajectory frame, said trajectory frame comprising a succession of segments between the starting point, the intermediate points and the target;

at least one trajectory primitive chosen from among a plurality of trajectory primitives.

The trajectory frame constitutes a basic trajectory that is discretized into various intermediate points. This trajectory frame takes account of the geometric constraints and the tactical constraints of the field of operation. The trajectory portions of this trajectory frame are however all rectilinear between the various intermediate points. To form time reserves, some of these rectilinear portions are modified into sinusoidal portions. These modifications are performed based on trajectory primitives. The trajectory primitives stem from a database that comprises normalized trajectory portions representing various types of trajectory (fast, covert, LLF for “low-level flight”, on the basis of a time loss criterion, on the basis of a fuel saving criterion) for various aircraft. Various aerodynamic configurations or payloads are taken into consideration for each aircraft.

In one particular embodiment, the trajectory frame is obtained from trajectory planning and from a time constraint associated with the given time for performing the action on the target.

This allows a real-time adaptation of the trajectory on the basis of the evolutions of the operational context of the field of operation.

Another subject of the invention relates to a device for determining a trajectory of an aircraft intended to fly over a field of operation with a view to performing an action on a target at a given time. The field of operation comprises a plurality of secure areas and a plurality of non-secure areas. The trajectory comprises a plurality of intermediate points between a starting point of said trajectory and the target, said intermediate points being positioned on borders between secure areas and non-secure areas. More specifically, the device comprises a module for computing a set of sections between said starting point, said intermediate points and said target, said set of sections comprising a first type of section extending over non-secure areas and a second type of section extending over secure areas. The first type of section has a rectilinear overall shape so as to limit the time spent by the aircraft in said non-secure area and the second type of section has a sinusoidal shape so as to allow a time reserve to adjust a position of the aircraft over the target at said given time with a view to performing the action.

In one particular embodiment, the device comprises a tactical situation database and an intelligent algorithm designed to determine a risk level for each of the areas based on said tactical situation database.

The intelligent algorithm is based on the data stemming from the tactical situation enhanced by data stemming from operational experts and past missions. All of this combined information is then processed by a block from the artificial intelligence, which is able, through learning, to associate a hazard level and a type of threat liable to be encountered in an area under consideration.

Another subject of the invention relates to a method for synchronizing actions on a target between a first aircraft intended to fly over a field of operation with a view to performing a first action on said target at a first given time and at least one second aircraft intended to fly over said field of operation with a view to performing a second action on said target at a second given time. The field of operation comprises a plurality of secure areas and a plurality of non-secure areas. Each aircraft has a trajectory comprising a plurality of intermediate points between a starting point and the target. The intermediate points are positioned on borders between secure areas and non-secure areas. The method is implemented by computerized means. The method comprises, for each aircraft, a step of computing a set of sections between said starting point, said intermediate points and said target, said set of sections comprising a first type of section extending over non-secure areas and a second type of section extending over secure areas. The first type of section has a rectilinear overall shape so as to limit the time spent by said aircraft in the non-secure areas. The second type of section has a sinusoidal shape so as to allow a time reserve to adjust the position of said aircraft over the target at said given time with a view to performing said action. The first given time and the second given time are selected so as to synchronize the first action performed by the first aircraft and the second action performed by the second aircraft on said target.

It is thus possible to determine spatio-temporally synchronized trajectories for multiple aircraft in a constricted environment with a view to ensuring success of the mission.

Another subject of the invention relates to a synchronization device for synchronizing actions on a target between a first aircraft intended to fly over a field of operation with a view to performing a first action on said target at a first given time and at least one second aircraft intended to fly over said field of operation with a view to performing a second action on said target at a second given time. The field of operation comprises a plurality of secure areas and a plurality of non-secure areas. Each aircraft has a trajectory comprising a plurality of intermediate points between a starting point and the target. The intermediate points are positioned on borders between secure areas and non-secure areas. The synchronization device comprises a computing module designed to compute, for each of said aircraft, a set of sections between said starting point, said intermediate points and said target. The set of sections comprises a first type of section extending over non-secure areas and a second type of section extending over secure areas, said first type of section having a rectilinear overall shape so as to limit the time spent by the aircraft in said non-secure area and said second section having a sinusoidal shape so as to allow a time reserve to adjust the position of the aircraft over the target at said given time with a view to performing the action. The first given time and the second given time are selected so as to synchronize the first action performed by the first aircraft and the second action performed by the second aircraft on said target.

Another subject of the invention relates to a platform designed to communicate with a first aircraft and at least with a second aircraft in order to synchronize actions on a target, said platform comprising a synchronization device according to one of the preceding subjects.

### BRIEF DESCRIPTION OF THE DRAWINGS

The present invention will be better understood upon reading the detailed description of embodiments, taken by way of completely non-limiting example and illustrated by the appended drawings, in which:

FIG. 1 illustrates a field of operation over which there is positioned a trajectory of an aircraft as obtained using a method for determining a trajectory according to the invention;

FIG. 2 illustrates the field of operation from FIG. 1 with a trajectory frame used to determine the trajectory of the aircraft;

FIG. 3 illustrates a device for determining the trajectory of the aircraft from FIG. 1;

FIG. 4 illustrates the steps of a method for determining the trajectory of the aircraft from FIG. 1;

FIG. 5 illustrates a field of operation over which there are positioned trajectories of two aircraft with a view to performing synchronized actions on a target using a synchronization method;

FIG. 6 illustrates a synchronization device for synchronizing actions of the aircraft from FIG. 5;

FIG. 7 illustrates the steps of a synchronization method for synchronizing actions of the aircraft from FIG. 5.

### DETAILED DESCRIPTION

The invention is not limited to the embodiments and variants that are presented, and other embodiments and variants will be readily apparent to those skilled in the art.

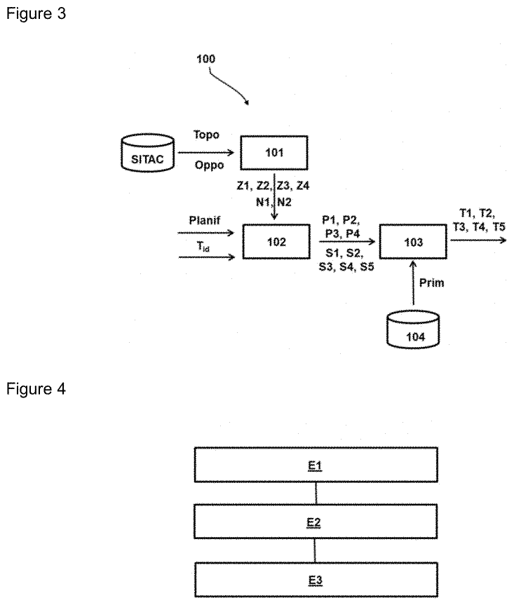

FIG. 3 thus illustrates a device 100 for determining the trajectory of an aircraft 10. This device 100 comprises:
a tactical situation database SITAC;
an intelligent algorithm 101;
a discretization module 102;
a computing module 103;
a database 104 of primitives.

The tactical situation database SITAC is designed to store all information describing the features of a field of operation 11, such as topographical features Topo and enemy presences Oppo.

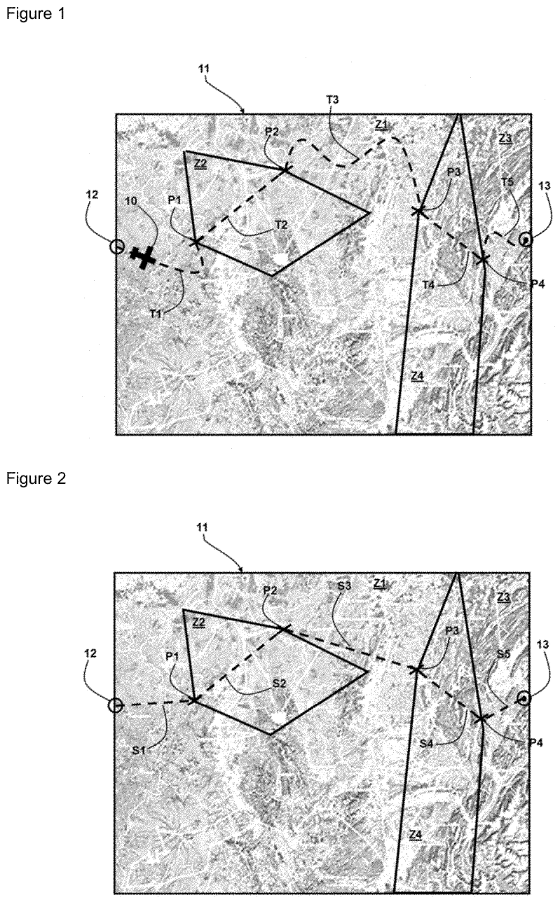

The intelligent algorithm 101 is designed to divide the field of operation 11 into a plurality of areas Z1, Z2, Z3, Z4 and to assign a risk level N1, N2 to each of these areas. A first risk level N1 corresponds to a low hazard level. A second risk level N2 corresponds to a high hazard level. In the field of operation 11 illustrated in FIGS. 1 and 2, a first area Z1 and a third area Z3 thus have a low risk level N1. These areas Z1, Z3 are said to be secure areas. In the same way, a second area Z2 and a fourth area Z4 have a high risk level N2. These areas Z2, Z4 are said to be non-secure. The intelligent algorithm 101 is thus designed to manage the risk levels of the various areas.

The discretization module 102 is designed to determine a trajectory frame of the aircraft 10 over the secure areas Z1, Z3 and over the non-secure areas Z2, Z4. As illustrated more specifically in FIG. 2, this trajectory frame comprises a succession of segments S1, S2, S3, S4 arranged between a starting point 12 of the aircraft 10 and a target 13. The segments S1, S2, S3, S4 are in the form of dashes linking a plurality of intermediate points P1, P2, P3, P4. A first segment S1 thus links the starting point 12 to a first intermediate point P1. A second segment S2 links the first intermediate point P1 to a second intermediate point P2. A third segment S3 links the second intermediate point P2 to a third intermediate point P3. A fourth segment S4 links the third intermediate point P3 to a fourth intermediate point P4. A fifth segment S5 links the fourth intermediate point P4 to the target 13. The intermediate points P1, P2, P3, P4 are positioned on borders between the secure areas Z1, Z3 and the non-secure areas Z2, Z4. The first intermediate point P1 is thus at the interface between the first secure area Z1 and the second non-secure area Z2. The second intermediate point P2 is also at the interface between the first secure area Z1 and the second non-secure area Z2. The third intermediate point P3 is at the interface between the first secure area Z1 and the fourth non-secure area Z4. The fourth intermediate point P4 is at the interface between the fourth non-secure area Z4 and the third secure area Z3.

The trajectory frame is obtained from trajectory planning Planif and from a time constraint associated with a given time Tid for performing an action on the target 13. The discretization module 102 then makes it possible to introduce the trajectory frame onto the field of operation 11, taking account of the safety constraints of each area Z1, Z2, Z3, Z4 and the time constraint Tid.

The database 104 is designed to store a plurality of primitives Prim. These primitives are normalized trajectories, addressing specific problems for a precise aircraft in a given configuration. This database of primitives comprises the various aircraft, such as fighter jets, drones, UCAV (for “unmanned combat air vehicle”) drones, surveillance drones, helicopters, remote carriers, etc. along with their various configurations (dependent on payloads, etc.), which represent a performance model for the trajectory. For each performance model, one or more primitives concern each hazard level and types of threats detected. The primitives may represent trajectories that are for example fastest in terms of time, shortest in terms of distance, stealthiest, save most fuel, etc.

The computing module 103 is designed to determine a set of sections T1, T2, T3, T4 between the starting point 12, the intermediate points P1, P2, P3, P4 and the target 13. This computing module 103 thus receives the location of the plurality of intermediate points P1, P2, P3, P4 over the field of operation 11 along with the segments S1, S2, S3, S4 between the starting point 12 and the target 13. The computing module 103 also receives one or more primitives from the database 104. Based on these various elements, the computing module 103 is able to deliver an appropriate trajectory. This trajectory thus comprises two types of section. In a first type of section, a second section T2 and a fourth section T4 have rectilinear shapes that extend into the second non-secure area Z2 and into the fourth non-secure area Z4, respectively. The first type of section with a rectilinear shape thus makes it possible to limit the time spent by the aircraft 10 in the non-secure areas Z2, Z4. The second section T2 thus corresponds to the second segment S2 of the trajectory frame and the fourth section T4 corresponds to the fourth segment S4 of said trajectory frame. In a second type of section, a first section T1, a third section T3 and a fifth section T5 have sinusoidal shapes that extend into the first secure area Z1 and into the third secure area Z3, respectively. The second type of section with a sinusoidal shape makes it possible to allow a time reserve to adjust a position of the aircraft 10 over the target 13 at the given time Tid with a view to performing the action on the target 13. This time reserve allows the pilot of the aircraft to have “fuses” in his trajectory, thereby allowing him to adapt his flight as best possible to time constraints during the operation. The device 100 for determining the trajectory thus makes it possible to place time “patterns” at strategic locations in order to perform the mission. Using the various information stemming from the tactical situation, through data fusion, the device 100 determines the various areas of the mission area that are presumed to be safe. The time loss “patterns” may then be inserted into the trajectory in an optimum manner.

FIG. 4 illustrates the steps of a method for determining a trajectory of the aircraft 10, implemented by the determination device 100 from FIG. 3. This determination method comprises a step E1 of dividing the field of operation 11 into a plurality of areas Z1, Z2, Z3, Z4. A risk level N1, N2 is associated with each of these areas. In a discretization step E2, the trajectory frame of the aircraft 10 is determined over the secure areas Z1, Z3 and over the non-secure areas Z2, Z4. As has already been explained, this trajectory frame comprises a succession of segments S1, S2, S3, S4, S5 between the starting point 12, the intermediate points P1, P2, P3, P4 and the target 13. This trajectory frame is obtained from the trajectory planning Planif and from the time constraint associated with the given time Tid for performing the action on the target 13. In a computing step E3, a set of sections T1, T2, T3, T4, T5 is computed. This set of sections is determined based on the trajectory frame and at least one trajectory primitive Prim chosen from among a plurality of trajectory primitives.

It should be noted that the trajectory of the aircraft 10 may be updated by this determination method during the flight of the aircraft 10 over the field of operation 11. The determination method is furthermore designed to manage the impact of randoms on various sections with propagation of effects.

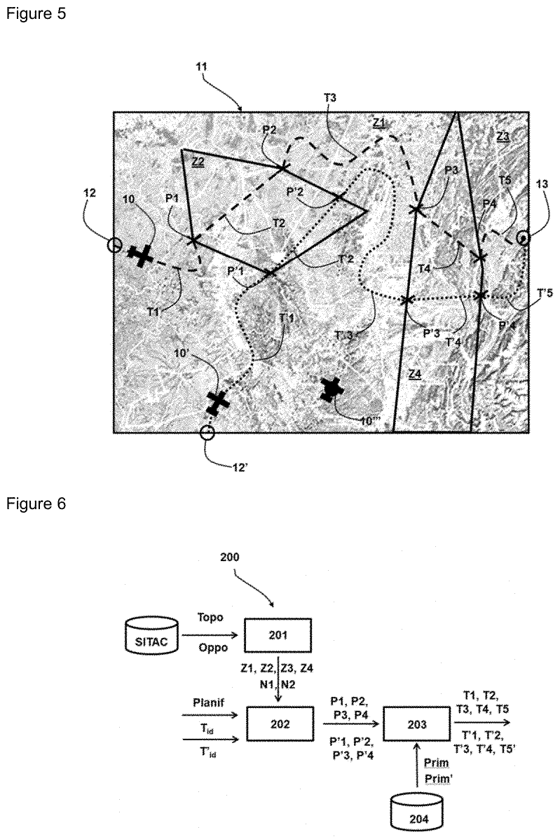

FIG. 5 illustrates a field of operation 11 flown over by two aircraft 10, 10′. The first aircraft 10 follows a first trajectory from the first starting point 12 to the target 13, passing through a first group of first intermediate points P1, P2, P3, P4. This trajectory was described in more specific detail in the description of FIG. 1.

The second aircraft 10′ follows a second trajectory from a second starting point 12′ to the target 13, passing through a second group of intermediate points P′1, P′2, P′3, P′4. The intermediate points P′1, P′2, P′3, P′4 of this second group of points are positioned on borders between the secure areas Z1, Z3 and the non-secure areas Z2, Z4. The first intermediate point P′1 is thus at the interface between the first secure area Z1 and the second non-secure area Z2. The second intermediate point P′2 is also at the interface between the first secure area Z1 and the second non-secure area Z2. The third intermediate point P′3 is at the interface between the first secure area Z1 and the fourth non-secure area Z4. The fourth intermediate point P′4 is at the interface between the fourth non-secure area Z4 and the third secure area Z3. The trajectory of the second aircraft 10′ comprises two types of section. In a first type of section, a second section T′2 and a fourth section T′4 have rectilinear shapes that extend into the second non-secure area Z2 and into the fourth non-secure area Z4, respectively. The first type of section with a rectilinear shape thus makes it possible to limit the time spent by the aircraft 10′ in the non-secure areas Z2, Z4. In a second type of section, a first section T′1 and a third section T′3 have sinusoidal shapes that extend into the first secure area Z1 and into the third secure area Z3, respectively. The second type of section with a sinusoidal shape makes it possible to allow a time reserve to adjust a position of the second aircraft 10′ over the target 13 at the given time T′id with a view to performing the action on the target 13. The actions of the first aircraft 10 and of the second aircraft 10′ on the target 13 have to be synchronized for good success of the operation.

FIG. 6 illustrates a synchronization device 200 for synchronizing actions on the target 13. This device 200 comprises, in the same way as for the device 100 from FIG. 3:
a tactical situation database SITAC;
an intelligent algorithm 201;
a discretization module 202;
a computing module 203;
a database 204 of primitives.

The discretization module 202 is designed to determine a first trajectory frame for the first aircraft 10 and a second trajectory frame for the second aircraft 10′ over the secure areas Z1, Z3 and over the non-secure areas Z2, Z4. The first trajectory frame is determined based on the trajectory planning Planif and the time constraint Tid associated with the first aircraft 10. The second trajectory frame is determined based on the trajectory planning Planif and the time constraint T′id associated with the second aircraft 10′. The first given time Tid and the second given time T′id are selected beforehand so as to synchronize the first action performed by the first aircraft 10 and the second action performed by the second aircraft 10′ on the target 13.

The computing module 203 is designed to determine a first set of sections T1, T2, T3, T4 between the first starting point 12, the first group of intermediate points P1, P2, P3, P4 and the target 13. This computing module 203 thus receives the location of the plurality of the first group of intermediate points P1, P2, P3, P4 over the field of operation 11. In the same way, the computing module 203 is designed to determine a second set of sections T′1, T′2, T′3, T′4 between the second starting point 12′, the first group of intermediate points P1, P2, P3, P4 and the target 13. This computing module 203 is thus able to receive the location of the plurality of the second group of intermediate points P′1, P′2, P′3, P′4 over the field of operation 11.

The computing module 203 is also able to receive a first primitive Prim in order to determine the first set of sections T1, T2, T3, T4 and a second primitive Prim′ in order to determine the second set of sections T′1, T′2, T′3, T′4. The first primitive Prim and the second primitive Prim′ are identical. As a variant, the first primitive Prim and the second primitive Prim′ are different.

The synchronization device 200 may be arranged on a platform 10″, for example a platform installed on another aircraft. This platform 10″ is designed to communicate with the first aircraft 10 and the second aircraft 10′ in order to synchronize actions on the target 13. The synchronization is preferably performed on the aircraft (10 or 10′) with which the most imminent given time (Id or Id′) with a view to performing the action on the target is associated. In one particular embodiment, the first aircraft 10 and the second aircraft 10′ have a constant speed and a constant altitude, and the synchronization then consists in modifying the departure time of the second aircraft 10′. In another embodiment, the first aircraft 10 and the second aircraft 10′ are synchronized by modifying features in terms of length, inter-segment route angle variation, speed and/or altitude of the respective trajectories of the first aircraft 10 and/or of the second aircraft 10′.

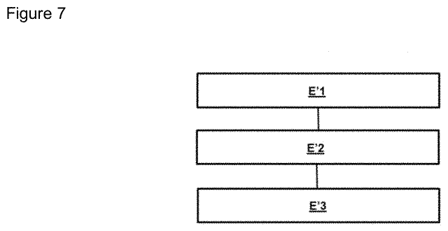

FIG. 7 illustrates the steps of a method for synchronizing actions on the target 13 between the first aircraft 10 and the second aircraft 10′. This determination method comprises a step E′1 of dividing the field of operation 11 into a plurality of areas Z1, Z2, Z3, Z4. A risk level N1, N2 is associated with each of these areas. In a discretization step E′2, the first trajectory frame of the first aircraft 10 and the second trajectory frame of the second aircraft 10′ are determined over the secure areas Z1, Z3 and over the non-secure areas Z2, Z4. The first trajectory frame is obtained from the trajectory planning Planif and from the first time constraint Tid. The second trajectory frame is obtained from the trajectory planning Planif and from the second time constraint T′id. The first given time Tid and the second given time T′id are selected beforehand so as to synchronize the first action performed by the first aircraft 10 and the second action performed by the second aircraft 10′ on the target 13.

In a step E′3, a first set of sections T1, T2, T3, T4 and a second set of sections T′1, T′2, T′3, T′4 are computed. The first set of sections is determined based on the first trajectory frame and at least one first trajectory primitive Prim chosen from among a plurality of trajectory primitives. The second set of sections is determined based on the second trajectory frame and at least one second trajectory primitive Prim′ chosen from among a plurality of trajectory primitives.

The invention thus proposes to combine global and local optimization methods enhanced by the provision of data via data fusion and/or artificial intelligence. Acceptable areas for a time loss are determined along with patterns that are more realistic (flyable trajectory) for the fuse sections.

The invention also proposes to use an intelligent algorithm to determine safe areas to introduce these time patterns and ensure compliance with time constraints, to use various trajectory primitives to create the trajectory under constraints on the basis of the operational context of the area, these trajectory primitives being consistent with a threat/hazard level expressed by the intelligent algorithm. The invention also makes it possible to determine routes and trajectories for each aircraft, in a constrained environment with the insertion of time loss patterns.

The invention thus facilitates mission planning, but also the planning of new flights upon an evolution of the tactical situation or upon an unexpected event.

Furthermore, on the operational level, the multi-carrier spatio-temporal synchronization makes it possible to reduce mental load on the pilot while at the same time automating computing operations.

1. A method for determining a trajectory of an aircraft intended to fly over a field of operation with a view to performing an action on a target at a given time (Id), said field of operation comprising a plurality of secure areas (Z1, Z3) and a plurality of non-secure areas (Z2, Z4), said trajectory comprising a plurality of intermediate points (P1, P2, P3, P4) between a starting point of said trajectory and the target, said intermediate points (P1, P2, P3, P4, P5) being positioned on borders between secure areas and non-secure areas, said method being implemented by computerized means, wherein said determination method comprises a step of computing (E3) a set of sections (T1, T2, T3, T4, T5) between said starting point, said intermediate points (P1, P2, P3, P4) and said target, said set of sections (T1, T2, T3, T4) comprising a first type of section (T2, T4) extending over non-secure areas (Z2, Z4) and a second type of section (T1, T3) extending over secure areas (Z1, Z3), said first type of section (T2, T4) having a rectilinear overall shape so as to limit the time spent by the aircraft in the non-secure areas (Z2, Z4) and said second type of section (T1, T3) having a sinusoidal shape so as to allow a time reserve to adjust a position of the aircraft over the target at said given time (T_{id}) with a view to performing the action.

2. The method for determining a trajectory according to claim 1, wherein the step of computing (E3) the set of sections (T1, T2, T3, T4, T5) is performed based on:
a trajectory frame, said trajectory frame comprising a succession of segments (S1, S2, S3, S4, S5) between the starting point, the intermediate points (P1, P2, P3, P4) and the target;
at least one trajectory primitive (Prim) chosen from among a plurality of trajectory primitives.

3. The method for determining a trajectory according to claim 2, wherein the trajectory frame is obtained from trajectory planning (Planif) and from a time constraint associated with the given time (T_{id}) for performing the action on the target.

4. The method for determining a trajectory according to claim 1, wherein said trajectory is updated during the flight of the aircraft over the field of operation.

5. A device for determining a trajectory of an aircraft intended to fly over a field of operation with a view to performing an action on a target at a given time (Id), said field of operation comprising a plurality of secure areas (Z2, Z4) and a plurality of non-secure areas (Z1, Z3), said trajectory comprising a plurality of intermediate points (P1, P2, P3, P4) between a starting point of said trajectory and the target, said intermediate points (P1, P2, P3, P4, P5) being positioned on borders between secure areas and non-secure areas, said device comprising:
a module for computing a set of sections (T1, T2, T3, T4, T5) between said starting point, said intermediate points (P1, P2, P3, P4) and said target, said set of sections (T1, T2, T3, T4) comprising a first type of section (T2, T4) extending over non-secure areas (Z2, Z4) and a second type of section (T1, T3) extending over secure areas (Z1, Z3), said first type of section (T2, T4) having a rectilinear overall shape so as to limit the time spent by the aircraft in the non-secure areas (Z2, Z4) and said second type of section (T1, T3, T5) having a sinusoidal shape so as to allow a time reserve to adjust a position of the aircraft over the target at said given time (T_{id}) with a view to performing the action.

6. The device for determining a trajectory according to claim 5, wherein said device comprises a tactical situation database (SITAC) and an intelligent algorithm designed to determine a risk level (Ni, N2) for each of the areas (Z1, Z2, Z3, Z4) based on said tactical situation database (SITAC).

7. A method for synchronizing actions on a target between a first aircraft intended to fly over a field of operation with a view to performing a first action on said target at a first given time (T_{id}) and at least one second aircraft intended to fly over said field of operation with a view to performing a second action on said target at a second given time (T′_{id}), said field of operation comprising a plurality of secure areas (Z1, Z3) and a plurality of non-secure areas (Z2, Z4), each aircraft having a trajectory comprising a plurality of intermediate points (P1, P2, P3, P4; P′1, P′2, P′3, P′4) between a starting point and the target, said intermediate points being positioned on borders between secure areas and non-secure areas, said method being implemented by computerized means, said method comprising, for each aircraft, a step of computing (E′3) a set of sections (T1, T2, T3, T4, T5; T′1, T′2, T′3, T′4, T′5) between said starting point, said intermediate points (P1, P2, P3, P4; P′1, P′2, P′3, P′4) and said target, said set of sections (T1, T2, T3, T4, T5; T′1, T′2, T′3, T′4, T′5) comprising a first type of section (T2, T4; T′2; T′4) extending over non-secure areas (Z2, Z4) and a second type of section (T1, T3; T′1, T′3) extending over secure areas (Z1, Z3), said first type of section (T2, T4; T′2; T′4) having a rectilinear overall shape so as to limit the time spent by the aircraft in the non-secure areas (Z2, Z4) and said second type of section (T1, T3, T5; T′1, T′3, T′5) having a sinusoidal shape so as to allow a time reserve to adjust the position of the aircraft over the target at said given time (T_{id}; T′_{id}) with a view to performing said action, said first given time (T_{id}) and said second given time (T′_{id}) being selected so as to synchronize the first action performed by the first aircraft and the second action performed by the second aircraft on said target.

8. A synchronization device for synchronizing actions on a target between a first aircraft intended to fly over a field of operation with a view to performing a first action on said target at a first given time (T_{id}) and at least one second aircraft intended to fly over said field of operation with a view to performing a second action on said target at a second given time (T′_{id}), said field of operation comprising a plurality of secure areas (Z1, Z3) and a plurality of non-secure areas (Z2, Z4), each aircraft having a trajectory comprising a plurality of intermediate points (P1, P2, P3, P4; P′1, P′2, P′3, P′4) between a starting point and the target, said intermediate points being positioned on borders between secure areas and non-secure areas, said synchronization device comprising a computing module designed to compute, for each of said aircraft, a set of sections (T1, T2, T3, T4, T5; T′1, T′2, T′3, T′4, T′5) between said starting point, said intermediate points (P1, P2, P3, P4; P′1, P′2, P′3, P′4) and said target, said set of sections comprising a first type of section (T2, T4; T′2, T′4) extending over non-secure areas (Z2, Z4) and a second type of section (T1, T3, T5; T′1, T′3, T′5) extending over secure areas (Z1, Z3), said first type of section (T2, T4; T′2, T′4) having a rectilinear overall shape so as to limit the time spent by the aircraft in the non-secure areas (Z2, Z4) and said second type of section (T1, T3, T5; T′1, T′3, T′5) having a sinusoidal shape so as to allow a time reserve to adjust the position of the aircraft over the target at said given time (T_{id}, T′_{id}) with a view to performing the action, said first given time (T_{id}) and said second given time (T′_{id}) being selected so as to synchronize the first action performed by the first aircraft and the second action performed by the second aircraft on said target.

9. A platform designed to communicate with a first aircraft and at least with a second aircraft in order to synchronize actions on a target, said platform comprising a synchronization device according to claim 8.
